(19) United States
(12) Patent Application Publication
(10) Pub. No.: US 2002/0087396 A1
(43) Pub. Date: Jul. 4, 2002

(54) Point-service system

(76) Inventor: Tomohito Shida, Tokyo (JP)

Correspondence Address: STAAS & HALSEY LLP, 700 11TH STREET, NW, SUITE 500, WASHINGTON, DC, 20001, US

(21) Appl. No.: 09/748,374

(22) Filed: Dec. 27, 2000

(30) Foreign Application Priority Data
Jul. 14, 2000 (JP) 2000-213777

(51) Int. Cl. G06F 17/60

(52) U.S. Cl. 705/14

(57) ABSTRACT

A point-service system is provided that can promote a circulation of the points so as to improve a value of using the points. The point-service system can be accessed by a customer who uses a terminal device via a network. The point-service system comprises a point database for recording an accumulated number of points for a customer, means for issuing a recognition code for the number of reserved points in accordance with a use request with the number of reserve points from the customer, and means for recording the issued recognition code 22a along with the number of reserve points.

### BACKGROUND OF THE INVENTION

1. Field of the Invention

The present invention relates to a point-service system that can be accessed by a customer who uses a terminal device via a network, and a recording medium.

In a store, a shopping mall, a supermarket, a department store, an electronic mall or other facilities, it is popular to issue points (service points) of a certain ratio to a customer's purchasing amount as a discount method.

It is desired to promote a circulation of the points so as to improve a value of using the points and to activate electronic commerce or normal dealing.

2. Description of the Prior Art

Conventionally, the issue of the points as well as the use of the point is performed in each facility.

For example, a customer who did a shopping in a store can hand a card issued in the store to a cashier so that the number of points corresponding to the purchase amount is added to the memory area of the card or of the memory device designated by the card.

The store, which sold various goods responding to the order of the customer, encloses tickets of points corresponding to the amount of bill that is sent to the customer at the end of month.

The customer accumulates the valid points of each store by different media.

In order to use the accumulated points, the customer brings the card or the tickets to the store for receiving goods or services corresponding to the number of the points.

As explained above, conventionally, the points can be used only in the facility that issued the points. In addition, the customer has to bring the card or the tickets to the facility that issued the points.

Generally, a customer does shopping in many facilities, and it is not easy to make effective use of the points issued by each facility. For example, concerning a store that the customer rarely uses, there is little opportunity to use the issued points, which will be invalid.

Thus, conventionally, the use value of the points is low due to the limited area of use, so the original purpose of issuing points, i.e., stimulating customer's appetite for shopping to activate businesses is not sufficiently achieved.

### SUMMARY OF THE INVENTION

The object of the present invention is to provide a point-service system that can promote a circulation of the points so as to improve a value of using the points.

A system of the present invention is a point-service system that can be accessed by a customer who uses a terminal device via a network. The system comprises a point database for recording the points accumulated for a customer, means for issuing a recognition code for usable number of points in accordance with a use request with the usable number of points from a customer, and means for recording the issued recognition code with the usable number of points.

In addition, the system further comprises a use management database for recording an identifying information of a customer, a number of reserved points (use points) and the recognition code along with information indicating whether the number of reserved points is used or not, means for referring to the use management database so as to answer a point-usable facility about whether the number of reserved points is usable or not in accordance with a reference request along with the number of reserved points and the recognition code form the point-usable facility, and means for recording that the number of reserved points of the reference request is used in the corresponding field of information indicating whether the number of reserved points is used or not when the number of reserved points is set to be usable.

In a preferred embodiment, the system further comprises means for subtracting the number of reserved points for which the recognition code is issued from the accumulated number of points, so as to record the remaining number of points as a new accumulated number of points in the point database, means for referring the use management database in accordance with a cancel request with the recognition code from the customer, so as to invalidate the recognition code when the information indicating whether the number of reserved points is used or not corresponding to the recognition code indicates unused, and means for adding the number of points for the invalidated recognition code to the accumulated number of points for the customer, so as to record the added number of points as a new accumulated number of points in the point database.

In addition, the point database includes a customer point database provided for each customer, the number of points for each point issuing facility that issued the points and the identifying information of the point issuing facility are recorded in the customer point database, and the operations of subtracting the number of reserved points for which the recognition code is issued and of adding the number of points for the invalidated recognition code are executed for the number of points that is recorded in the customer point database.

Furthermore, the system comprises means for transmitting a use request display for the customer to view the accumulated number of points and to input the number of reserved points to the terminal device of the customer.

A recording medium storing a program for realizing the point-service system according to the present invention enables a computer to execute the process comprising the steps of issuing a recognition code for a number of reserved points in accordance with a point use request along with the number of reserve points from the customer, recording the issued recognition code with the number of reserved points, and subtracting the number of reserved points from the accumulated number of points for the customer, so as to record the remaining number of points as a new accumulated number of points.

The point-service system according to the present invention is realized by using a personal computer, a workstation, or a general-purpose computer, for example. The program for executing the process according to the present invention is stored in a recording medium such as a semiconductor memory, a hard disk, a CD-ROM, a floppy disk or a magneto-optical disk. The program stored in the recording medium is loaded on a main memory and is executed by a processor. On this occasion, a CD-ROM drive, a floppy disk drive or a magneto-optical disk drive, or other drive is used as necessary. If the recording medium is provided to a server that is connected to a communication line of a network, the program is read out or downloaded from the server via the communication line. The program can be supplied so as to work on various operating systems and platforms, or under system conditions and network conditions.

### BRIEF DESCRIPTION OF THE DRAWINGS

FIG. 1 is a block diagram showing the entire system including the point-service system according to the present invention.

FIGS. 2-5 are diagrams showing examples of point databases.

FIG. 6 is a diagram showing an example of a customer point database.

FIG. 7 is a diagram showing an example of a use management database.

FIG. 8 is a diagram showing a use request display displayed on the user terminal.

FIG. 9 is a diagram showing an issue confirming display.

FIG. 10 is a diagram showing a point ticket display.

FIG. 11 is a diagram showing a printed point use ticket.

FIG. 12 is a diagram showing a use state confirming display.

FIG. 13 is a flowchart showing a procedure of issuing a point use ticket.

FIG. 14 is a flowchart showing a process of issuing the ticket.

FIG. 15 is a flowchart showing a procedure of using the point use ticket.

FIG. 16 is a flowchart showing a reference process.

FIG. 17 is a diagram showing a form of a recording medium storing a program.

### DESCRIPTION OF THE PREFERRED EMBODIMENTS

Hereinafter, the present invention will be explained more in detail with reference to embodiments and drawings.

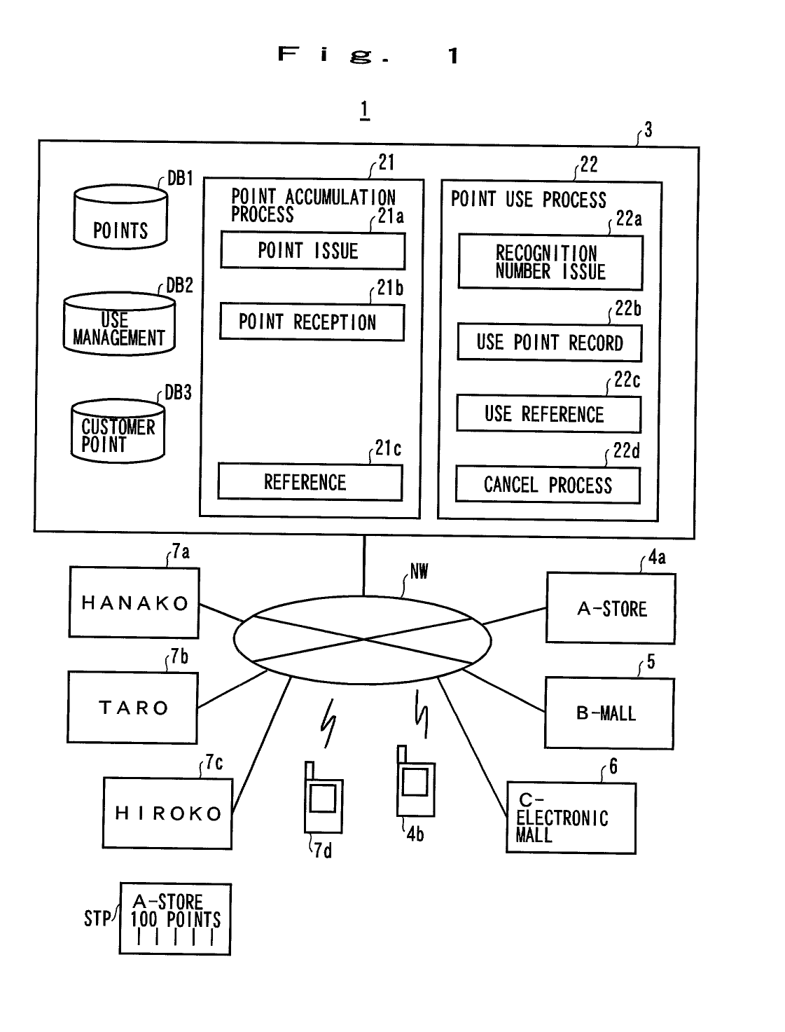

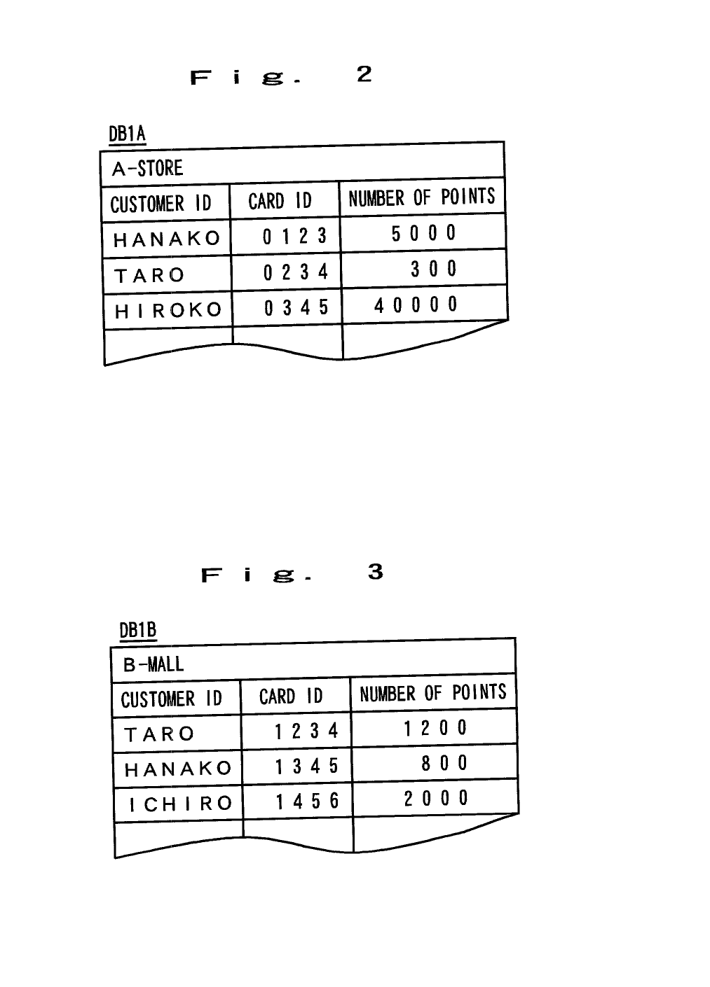

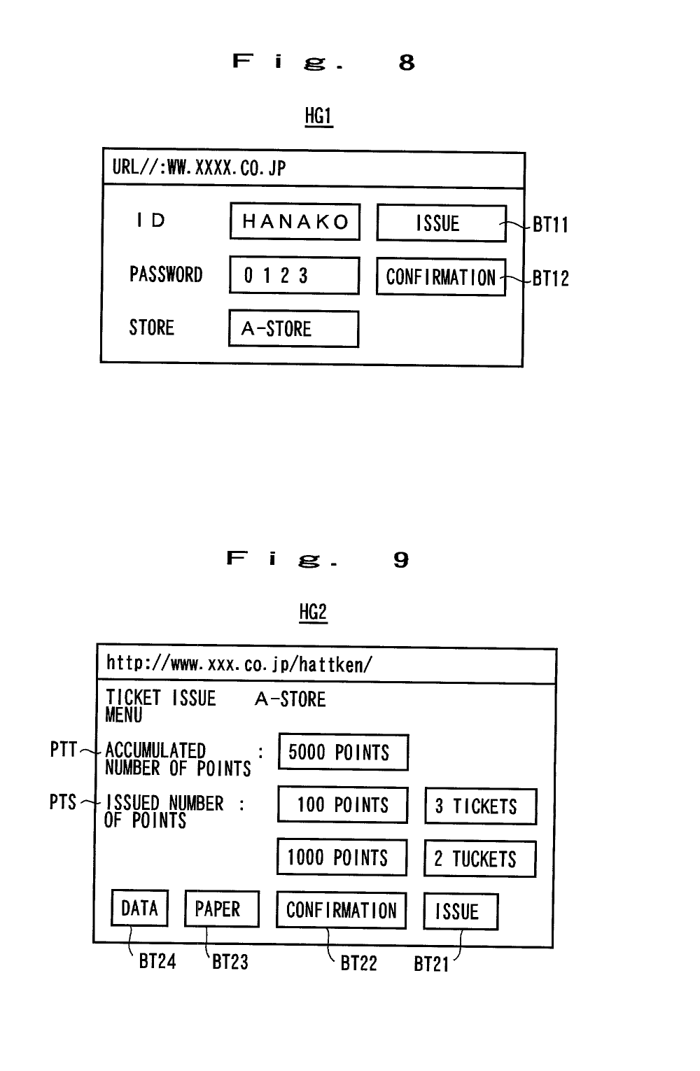

FIG. 1 is a block diagram showing the entire system 1 including the point-service system 3 according to the present invention. FIGS. 2-5 are diagrams showing examples of point databases DB1A-DB1D. FIG. 6 is a diagram showing an example of a customer point database DB3. FIG. 7 is a diagram showing an example of a use management database DB2.

In FIG. 1, the entire system 1 comprises a support system 3, terminal devices 4a, 4b, . . . that are administered by A-store and other stores, a terminal device 5 that is administered by B-mall, a site 6 of an electronic mall, user terminals 7a, 7b, 7c, . . . , and they are connected to the Internet NW.

The point-service system 3 is a system for charging points issued by a service that is administered by a company administering the system, e.g., a reservation service in this embodiment, or points issued by other stores having a contractual relationship or electronic mall. The point-service system 3 can be accessed by the terminal devices 4, 5, the site 6, and the user terminal 7 via the Internet.

The point-service system 3 comprises point databases DB1A, DB1B, DB1C, . . . , a use management database DB2, a customer point database DB3, a point accumulation processing portion 21, and a point use processing portion 22.

The point databases DB1A, DB1B, DB1C, DB1D register an accumulated number of points of a customer for each store. Here, a number of points issued by the A-store, the B-mall, the C-electronic mall, or the reservation service is recorded. Any one of these point databases DB1A-DB1D or the whole may be referred to as “point database DB1.” It is the same in the others.

As shown in FIG. 2, the point database DB1A records a customer ID, a card ID and an accumulated number of points for the A-store. The customer ID can be a name of the customer, a nickname or other code that can identify the customer. The card ID is an identifying code of a card that is provided to a customer from a store for issuing or accumulating points and for the customer to use. The customer ID and the card ID identify the customer. One of them can be omitted if the other can identify the customer. The number of points is a sum of points issued to each customer.

The point database DB1B shown in FIG. 3 is for the B-mall, and its content is the same as that for the point database DB1A shown in FIG. 2.

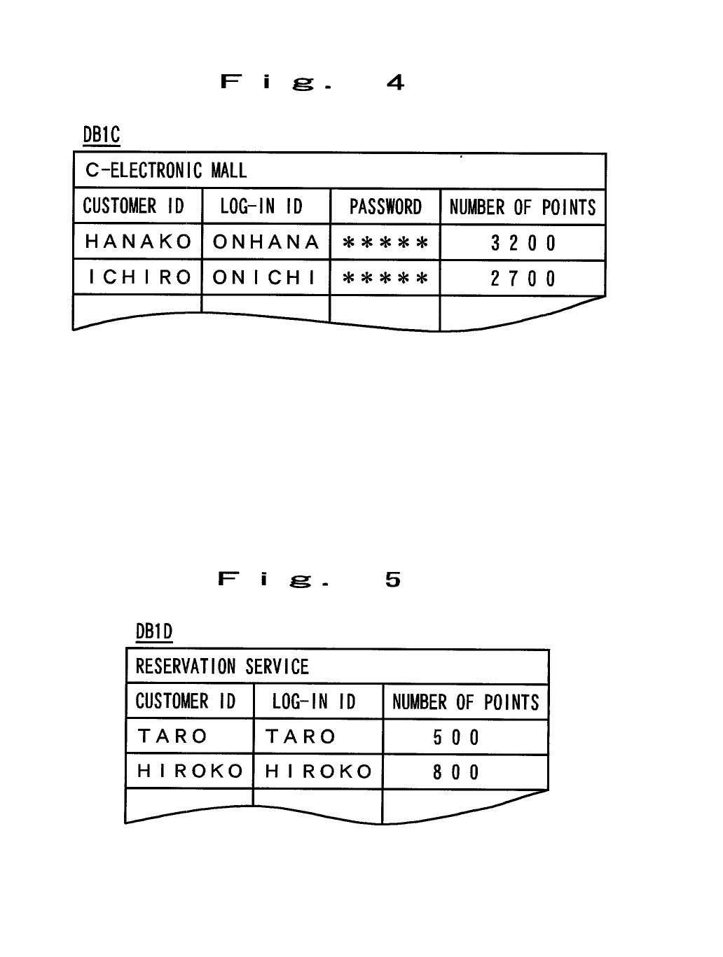

As shown in FIG. 4, the point database DB1C records the customer ID, a login ID, a password, and the number of points for the C-electronic mall. The login ID and the password are used by each customer when logging in the C-electronic mall or when buying goods.

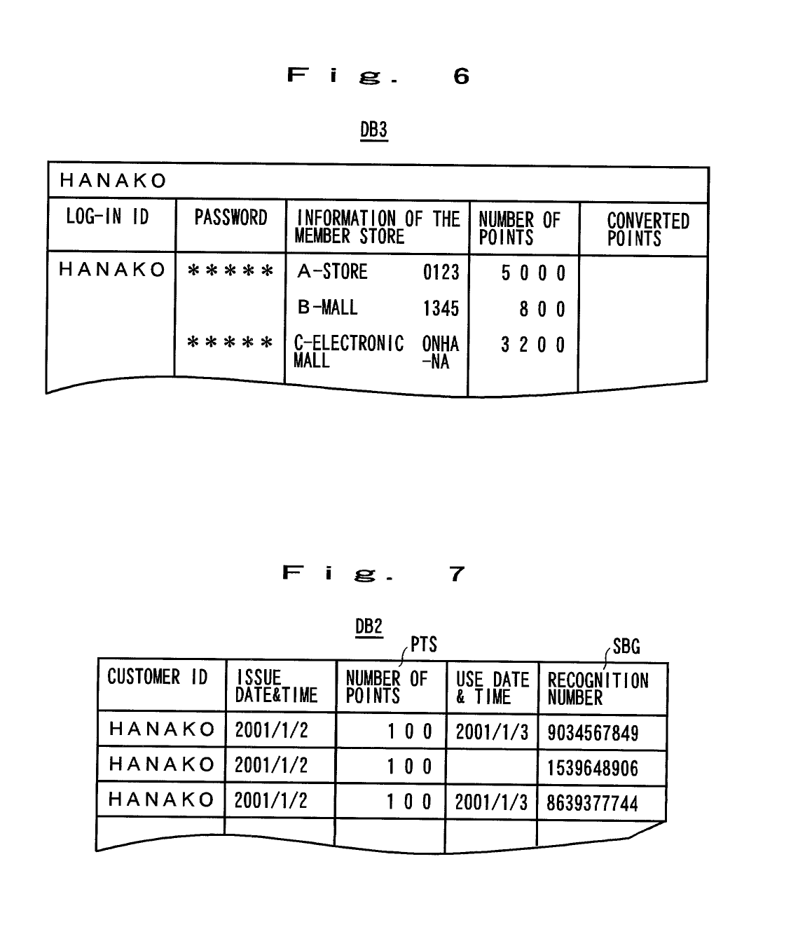

The point database DB1D shown in FIG. 5 records the customer ID, the login ID and the number of points for the reservation service.

In FIG. 6, the customer point database DB3 records the accumulated number of points for the customer in the same way as the point database DB1, and it is provided not for each store but for each customer.

Namely, the customer point database DB3 shown in FIG. 6 is for the customer “HANAKO,” and the login ID, information of the member store, the number of points and converted points for each facility that the customer uses.

The customer point database DB3 can be made in accordance with the data recorded in the point database DB1. If the customer point database DB3 is used for issuing a point use ticket ST, the number of points recorded in the customer point database DB3 is erased from the original point database DB1. If the customer point database DB3 is used only for referring, the data in the point database DB1 are maintained.

In addition, the customer point database DB3 can be made independently of the point database DB1. In that case, the customer can use either the customer point database DB3 or the point database DB1.

As shown in FIG. 7, the use management database DB2 records the customer ID, the date and time when the point use ticket was issued, which will be explained later, the number of points of the issued point use ticket, the date and time when the point use-ticket was used and the recognition number. The “recognition number” corresponds to the recognition code of the present invention.

When the point-service system 3 issues the point use ticket to the customer, a new record is generated in the use management database DB2. When the issued point use ticket is used, the date and time are recorded in the field of the date and time when the point use ticket is used. Therefore, if no data are recorded in the field of the use date and time, it is regarded that the issued point use ticket is not used. If the data are recorded in the field of the use date and time, it is regarded that the issued point use ticket is used. Namely, the “use data and time” corresponds to the information indicating whether the number of use points (reserved points) is used or not in the present invention.

In addition, when there is a request to cancel the issued point use ticket, the corresponding record is deleted, or the recognition number is erased or is changed to a particular number, or data are recorded in the use date and time field, so that the recognition number is invalidated.

Referring to FIG. 1 again, the point accumulation processing portion 21 includes a point issuing portion 21a, a point receiving portion 21b and a referring portion 21c.

The point issuing portion 21 a issues points to a customer under a predetermined condition and records the issued number of points in the point database DB1 or the customer point database DB3. Namely, it issues points responding to a request from the system cooperating with the point-service system 3 of the reservation service and other services.

The point receiving portion 21b receives the point information transmitted from the terminal devices 4, 5 or the site 6 and records in the point database DB1 or the customer point database DB3 in accordance with the received point information. Thus, the points that were issued by other stores or the electronic mall are charged by the point-service system 3.

The referring portion 21c, responding to a customer or a store, refers the point database DB1 or the customer point database DB3 so as to output an answer.

The point use processing portion 22 includes a recognition number issuing portion 22a, a use point recording portion 22b, a use referring portion 22c, a cancel processing portion 22d.

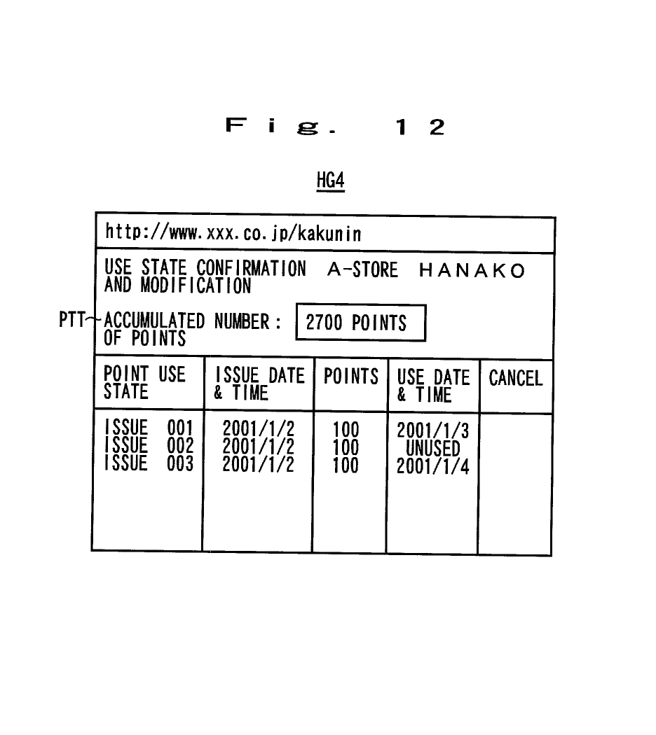

The recognition number issuing portion 22a generates a recognition number for the requested number of use points in accordance with a use request of the points from the customer and issues a point use ticket ST (see FIG. 10). The recognition number can be any number or code having uniqueness. For example, a plurality of random numbers of an appropriate digit can be generated and combined for the recognition number.

The use point recording portion 22b records a recognition number that was generated when issuing the point use ticket ST, a customer ID, an issue date and time, and the number of points in the use management database DB2.

The use referring portion 22c verifies the customer ID, the number of points and the recognition number that have been transmitted with the reference request with the record in the use management database DB2 concerning the point use ticket when there is the reference request from a point-usable facility such as a store or a mall. If there are the identical unused data in the use management database DB2, it is decided that the point use ticket is usable. If there are no identical unused data, it is decided that the point use ticket is unusable. Then, the decision is transmitted to the point-usable facility that has sent the reference request.

Furthermore, the use referring portion 22c records the date and time in the use data and time field of the use management database DB2 when the point use ticket is set to be usable responding to the reference request.

The cancel processing portion 22d refers the use management database DB2 concerning the point use ticket in accordance with the cancel request from a customer, so as to verify the customer ID, the number of points, and the recognition number that have been transmitted with the request with the record in the use management database DB2. If there are identical unused data in the use management database DB2, the data are invalidated. As a result, the point use ticket becomes unusable. In addition, the number of points of the invalidated point use ticket is added to the accumulated number of points of the customer, and the added number of points is recorded as a new accumulated number of points in the point database DB1A or the customer point database DB3 so as to be reusable points. Then, it is notified to the customer that the point use ticket is invalidated.

In addition, the point-service system 3 transmits various displays for each screen of the terminal devices 4, 5, the site 6 and the user terminal 7 to them and receives various data that are inputted on the display.

The point-service system 3 is realized by using a personal computer, a workstation or a general-purpose computer. The point accumulation processing portion 21 and the point use processing portion 22 are realized by a CPU that executes a program.

The terminal devices 4, 5 and 7 are equipment that can access the point-service system 3 via the Internet NW. They have display devices for displaying various displays that are transmitted from the point-service system 3 and for inputting various data or instructions, which are transmitted to the point-service system 3.

As the terminal devices 4, 5 and 7, a personal computer, a special-purpose terminal device, a cellular phone, a mobile device, a game machine, or other various devices can be used. It is preferable that the user terminal 7 has a printer for printing the point use ticket STP.

The site 6 can be accessed from the terminal device 7 via the Internet NW. Normally, a personal computer or a workstation constitutes the terminal device 7.

Next, the process and the operation of the point-service system 3 for using points with reference to the display HG that is displayed on the screen of the user terminal 7.

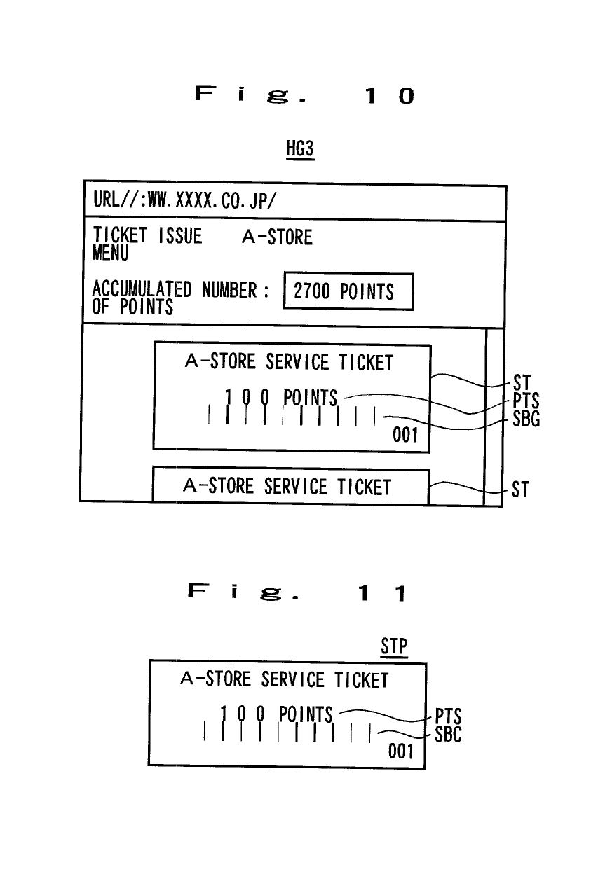

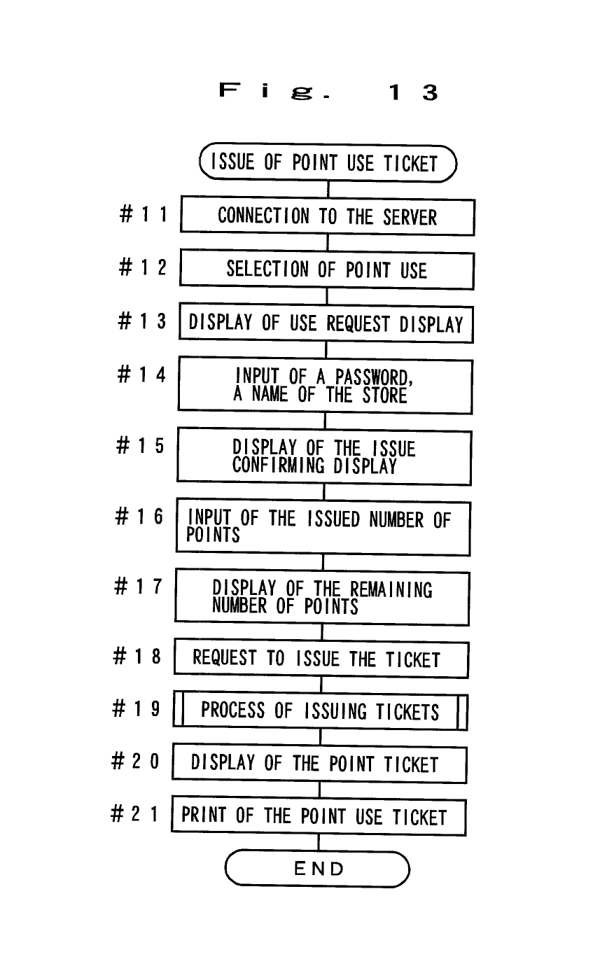

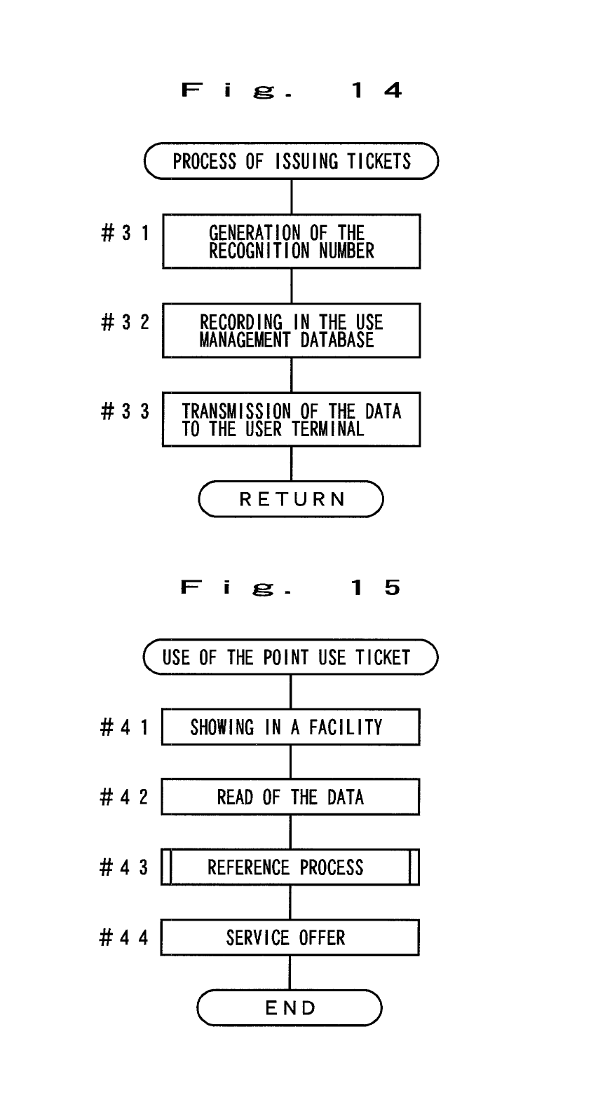

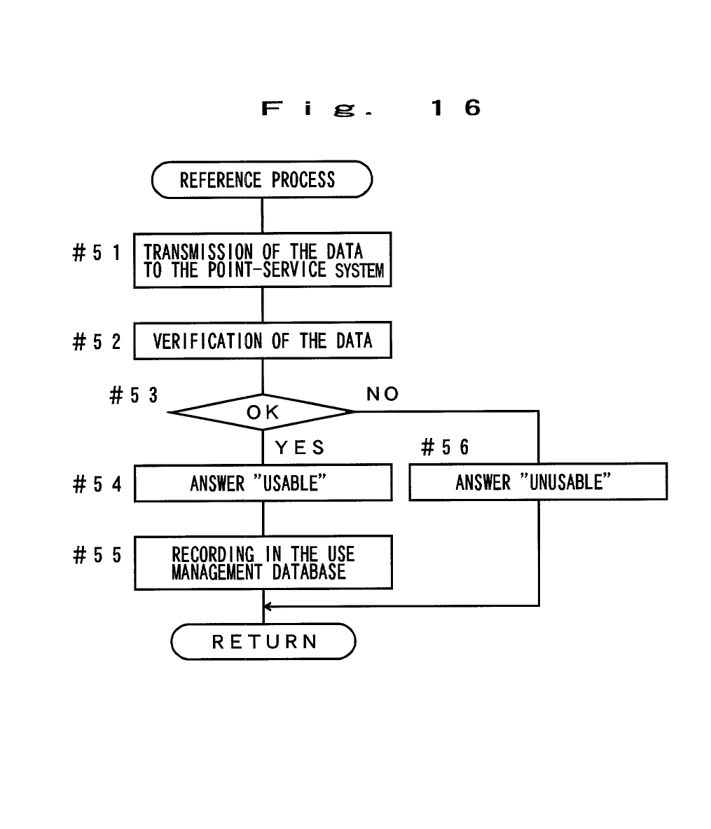

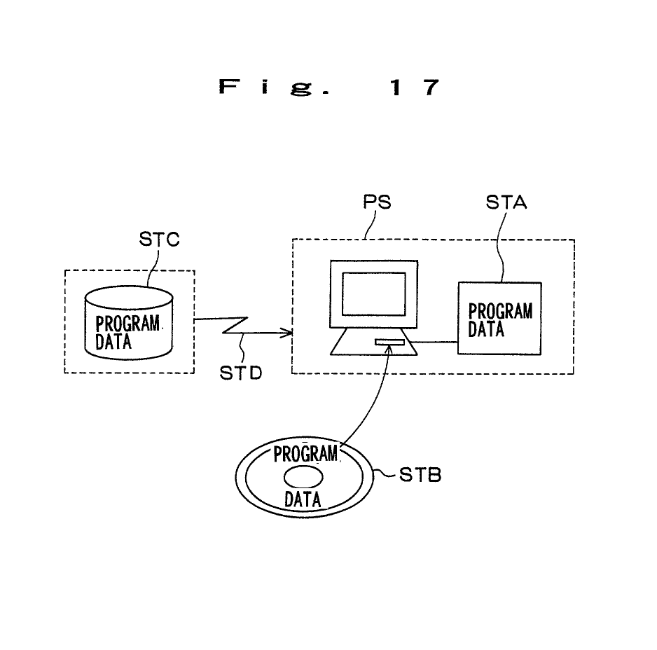

FIG. 8 is a diagram showing a use request display HG1 displayed on the user terminal 7. FIG. 9 is a diagram showing an issue confirming display HG2. FIG. 10 is a diagram showing a point ticket display HG3. FIG. 11 is a diagram showing a printed point use ticket STP. FIG. 12 is a diagram showing a use state confirming display HG4. FIG. 13 is a flowchart showing a procedure of issuing a point use ticket. FIG. 14 is a flowchart showing a process of issuing the ticket. FIG. 15 is a flowchart showing a procedure of using the point use ticket. FIG. 16 is a flowchart showing a reference process.

Points that were charged in the point-service system 3 in this embodiment can be used in any point-usable facility. In addition, a customer can assign his or her points to another person freely. The person to whom the points were assigned can use the points in any point-usable facility.

In this way, the use area of the points can be widened by the point-service system 3, so that a circulation of the points can be promoted. The point use ticket ST is issued for this use. The procedure of issuing the point use ticket is as follows.

In FIG. 13, a customer who has an intention to use the points operates the user terminal 7 first so as to connect it with the point-service system 3 via the Internet NW (#11). After the connection, the customer selects using points in a menu display (not shown) (#12), when a use request display HG1 is displayed on the screen of the user terminal 7 as shown in FIG. 8 (#13).

The customer inputs necessary items such as his or her customer ID, password and a store name in which the points to be used are accumulated, so as to transmit them to the point-service system 3 (#14). An image can be used instead of a numeric password or a code.

The point-service system 3 confirms the customer (the user) by the customer ID and the password that were inputted from the use request display HG1. When the confirmation of the customer is finished, the issue confirming display HG2 is displayed on the user terminal 7 as shown in FIG. 9 (#15).

The issue confirming display HG2 displays a ticket issuing menu for the A-store. The ticket issuing menu displays an accumulated number of points PTT, and the customer inputs the number of points and the number of tickets concerning the point use ticket ST to be issued (#16).

For example, the customer “HANAKO” has 5000 accumulated points for the A-store. It is instructed to issue the point use tickets ST including three 100-point use tickets STP and two 1000-point use tickets STP, which make 2300 points in total.

In addition, concerning the form of issuing, the button BT23 is clicked for issuing in paper, i.e., a printer matter. Otherwise, the button BT24 is clicked for issuing as data.

It is possible to display a list of the number of points PTS accumulated in all stores regarding the customer, instead of the display of the accumulated number of points PTT only for the A-store in the issue confirming display HG2.

When the button BT22 is clicked, the sum of the number of points to be issued is calculated, and the remaining number of points after the issued number of points is subtracted from the accumulated number of points is displayed as a new accumulated number of points (#17). When the button BT21 is clicked (#18), a ticket issuing process for issuing the point use ticket ST is executed in the point-service system 3 (#19).

In the ticket issuing process shown in FIG. 14, each recognition number SBG is generated for issuing the point use ticket ST of each number of points in accordance with the use request of points from a customer (#31). The generated recognition number SBG is recorded along with the customer ID, the issue date and time and the number of points in the use management database DB2 (#32). Then, the data are transmitted to the user terminal 7 in a predetermined form (#33).

Referring to FIG. 13 again, the point ticket display HG3 is displayed on the user terminal 7 after the ticket issue (#20).

In the point ticket display HG3 shown in FIG. 10, each point use ticket ST is displayed one by one. The point use ticket ST displays the number of points PTS and the recognition number SBG. The point use ticket ST of this example displays the recognition number SBG with a bar code. The bar code includes the number of points PTS. Namely, the number of points PTS displays by both the number and the bar code. It is possible to display the recognition number SBG by a number for manual input.

The customer can scroll the display so as to display all point use tickets ST.

The point use ticket ST displayed on the screen is printed so as to obtain the point use ticket STP that is shown in FIG. 11 (#21).

Next, a procedure of using the point use ticket STP will be explained.

The point use ticket STP displays the number of points PTS and the recognition number SBG in the same way as the point use ticket ST that is displayed in the point ticket display HG3. Anyone can use the point use ticket STP. Namely, the point use ticket STP owned by a customer can be assigned to another person.

In addition, it is possible to print a plurality of point use tickets STP from one point use ticket ST in the point ticket display HG3. However, there is only one point use ticket STP that can be used, i.e., it can be used only once for one recognition number SBG and its number of points PTS. When the paper form is requested in the issue confirming display HG2, the point use ticket ST is normally used as a printed paper point use ticket STP.

In FIG. 15, the printed point use ticket STP is brought to an appropriate point-usable facility and is shown there (#41). Here, it is used in the B-mall, for example.

The point use ticket STP has a display “A-store service ticket.” This indicates that it is based on points issued by the A-store, and does not indicate a place in which the point use ticket ST is to be used. Namely, the point use ticket STP can be used in any point-usable facility that has a contract about the use with the point-service system 3. Such point-usable facilities normally include the A-store, the B-mall and the C-electronic mall.

In the point-usable facility in which the point use ticket STP is shown, i.e., in the B-mall of this example, data are read out automatically from the shown point use ticket STP or are inputted manually by using a terminal device 5 or another cash register (#42). Since the number of points PTS and the recognition number SBG are displayed by the bar code, they are easily read by a bar code reader.

Instead of bringing the point use ticket STP, it is possible to use e.g., a cellular phone as the user terminal 7, and to bring the cellular phone to the point-usable facility after receiving the data of the point use ticket ST, so as to transmit the content of the point use ticket ST displayed on the screen of the cellular phone to a POS terminal or a cash register for data input using a wireless communication.

When the content of the point use ticket ST is read, a reference process is executed for checking whether the point use ticket ST is a valid or not (#43).

In the reference process, as shown in FIG. 16, the recognition number SBG and the number of points PTS that were read in the point-usable facility are transmitted to the point-service system 3 via the Internet NW (#51). In the point-service system 3, the use referring portion 22c verifies the received number of points PTS and the received recognition number SBG with the record in the use management database DB2 (#52).

If there are the identical unused data in the use management database DB2, it is decided that the point use ticket is usable. If there are no identical unused data, it is decided that the point use ticket is unusable. Then, the decision is transmitted to the point-usable facility that has sent the reference request (#53, #54, #55).

Furthermore, the date and time are recorded in the use management database DB2 when the point use ticket STP is set to be usable responding to the reference request. Thus, the point use ticket STP becomes used.

The point-usable facility provides goods or services corresponding to the number of points PTS of the point use ticket STP (#44).

Next, a process of canceling the point use ticket STP will be explained.

A customer can request to cancel the issued point use ticket STP at any time, so as to make it unusable.

Namely, for the point use ticket STP, the recognition number SBG and the number of points PTS are transmitted to the point-service system 3. The point-service system 3 verifies the data received along with the cancel request with the record in the use management database DB2. If there are identical unused data, the data are erased, so as to add the number of points PTS to the accumulated number of points PTT of the customer.

Thus, the point use ticket STP becomes unusable. Accordingly, when losing the point use ticket STP, the point use ticket STP can be invalidated in accordance with the point use ticket ST remaining in the point ticket display HG3, so as to prevent the use by another person.

In addition, the customer can confirm the use state of the accumulated points.

Namely, when a confirmation request is transmitted from the user terminal 7 to the point-service system 3, the use state confirming display HG4 is displayed as shown in FIG. 12.

In the use state confirming display HG4, the present accumulated number of points PTT is displayed for each store, and the issue date and time, the number of points PTS, the use date and time, the state of cancel or not are display for the issued point use ticket STP.

FIG. 17 is a diagram showing a form of a recording medium ST storing a program for realizing the point-service system 3 according to the present invention.

As shown in FIG. 17, a memory device STA such as a main memory, a RAM, a ROM or a hard disk provided in a processing device PS, a transportable medium STB such as a CD-ROM, a floppy disk or a magnet-optical disk, an on-line medium STC such as a server or a DASD connected via a network or a communication line STD, or a communication line STD itself can be used as the recording medium ST.

If the recording medium ST is a transportable medium STB, the program can be read by a drive device corresponding to the kind of the transportable medium STB, so as to be stored in the memory device STA of the processing device PS or loaded on the main memory for execution. If the recording medium ST is an on-line medium STC, the program is downloaded to the memory device STA via the communication line STD, or is transmitted for timely execution. The program can be supplied so as to work on various operating system and platforms or under various system environment or network environment.

According to the above-explained point-service system 3, the customer who accumulated points can easily have point use tickets STP issued at any time and use the issued point use ticket STP at any time and in any place without an authentication. In addition, the point use ticket STP can be assigned to anyone, who can use the point use ticket STP or assign it to anyone freely in the same way as the original owner.

Thus, the point use ticket STP can handle points in the same way as cash, so that a circulation of the points can be promoted, and the value of using the points is improved.

In addition, the recognition number SBG is merely a number or a code, and is verified when the point use ticket STP is used, which is usable only at one time. Therefore, even if the point use ticket STP is duplicated, no problem occurs. In addition, even if the point use ticket STP is lost, it is prevented that another person uses the ticket by doing the cancel request at an early stage.

A customer can operate the user terminal 7 at home, for example, so as to have a multitude of point use tickets STP by dividing the accumulated number of points into an appropriate number of points PTS. Therefore, the use form is diversified, and the value of use is improved. For example, the point use ticket STP can be given to a child as a spending money.

In addition, instead of a paper point use ticket STP, a data point use ticket ST can be transmitted to another user terminal 7 via an electronic mail or can be transmitted to an acquaintance living in a distant place via the Internet NW. It is also possible to use a coupon ticket that was exchanged with the points as a gift ticket.

A customer, who has an environment for connecting the Internet NW, can receive a service by accessing the point-service system 3 without any additional investment. Furthermore, it is possible to integrate the points accumulated in plural stores to the customer point database DB3, which can be managed by one customer ID.

In the above-explained embodiment, the structure, the shape and the number of the whole or a part of the point-service system 3, the terminal devices 4, 5, the site 6, the user terminal 7 or the system 1, the procedure or the content of the process, and the contents of the display can be modified in accordance with the object of the present invention.

According to the present invention, a circulation of the points can be promoted, and the value of using the points is improved.

While the presently preferred embodiments of the present invention have been shown and described, it will be understood that the present invention is not limited thereto, and that various changes and modifications may be made by those skilled in the art without departing from the scope of the invention as set forth in the appended claims.

What is claimed is:

1. A point-service system that can be accessed by a customer who uses a terminal device via a network, the system comprising:
a point database for recording the number of points accumulated for a customer;
means for issuing a recognition code for usable number of points in accordance with a use request with the usable number of points from a customer; and
means for recording the issued recognition code with the usable number of points.

2. The point-service system according to claim 1, further comprising:
a use management database for recording an identifying information of a customer, a number of reserved points and the recognition code along with information indicating whether the number of reserved points is used or not;
means for referring to the use management database so as to answer a point-usable facility about whether the number of reserved points is usable or not in accordance with a reference request along with the number of reserved points and the recognition code form the point-usable facility; and
means for recording that the number of reserved points of the reference request is used in the corresponding field of information indicating whether the number of reserved points is used or not when the number of reserved points is set to be usable.

3. The point-service system according to claim 1, further comprising:
means for subtracting the number of reserved points for which the recognition code is issued from the accumulated number of points, so as to record the remaining number of points as a new accumulated number of points in the point database;
means for referring the use management database in accordance with a cancel request with the recognition code from the customer, so as to invalidate the recognition code when the information indicating whether the number of reserved points is used or not corresponding to the recognition code indicates unused; and
means for adding the number of points for the invalidated recognition code to the accumulated number of points for the customer, so as to record the added number of points as a new accumulated number of points in the point database.

4. The point-service system according to claim 3, wherein
the point database includes a customer point database provided for each customer,
the number of points for each point issuing facility that issued the points and the identifying information of the point issuing facility are recorded in the customer point database, and
the operations of subtracting the number of reserved points for which the recognition code is issued and of adding the number of points for the invalidated recognition code are executed for the number of points that is recorded in the customer point database.

5. The point-service system according to claim 1, further comprising means for transmitting a use request display for the customer to view the accumulated number of points and to input the number of reserved points to the terminal device of the customer.

6. A recording medium storing a program for a point-service system that can be accessed by a customer who uses a terminal device via a network, the program enabling a computer to execute the process comprising the steps of:
issuing a recognition code for a number of reserved points in accordance with a point use request along with the number of reserve points from the customer;
recording the issued recognition code with the number of reserved points; and
subtracting the number of reserved points from the accumulated number of points for the customer, so as to record the remaining number of points as a new accumulated number of points.
